(19) United States
(12) Patent Application Publication
(10) Pub. No.: US 2026/0307028 A1
(43) Pub. Date: Oct. 8, 2026

(54) Pigment Mixing Method and Tool

(71) Applicant: Qmiet Inc., Roswell, GA (US)

(72) Inventor: Min CHEN, Shanghai (CN)

(21) Appl. No.: 19/429,970

(22) Filed: Dec. 22, 2025

(30) Foreign Application Priority Data
Apr. 8, 2025 (CN) 202510437903.4

(51) Int. Cl. B01F 35/22; B01F 35/221; B01F 101/30

(52) U.S. Cl. CPC B01F 35/2203; B01F 35/2202; B01F 35/2217; B01F 2101/30

(57) ABSTRACT

A pigment color-mixing method and tool is provided. In the method, a first lightness value of a target color is obtained, and a first formulated pigment is prepared based on black pigment and white pigment according to a preset ratio corresponding to the first lightness value, wherein the lightness of the first formulated pigment is the first lightness value. A second formulated pigment is prepared based on base hue pigments, wherein the lightness of the second formulated pigment is the first lightness value and the hue of the second formulated pigment is the hue of the target color. The first formulated pigment and the second formulated pigment are mixed to obtain a final formulated pigment.

### TECHNICAL FIELD

The present disclosure relates to the field of color mixing, specifically to a method and tools for color mixing of pigments.

### BACKGROUND

In various fields such as painting, design, and industry, color mixing has always been core skill. Most existing color mixing methods rely on a color mixer's intuitive visual perception and long-term accumulated experience to manually mix colors that approximate the target color. However, this approach relies excessively on individual sensory acuity and experience, is significantly influenced by environmental factors, and lacks scientific and systematic methods for mixing colors, resulting in deficiencies in both efficiency and accuracy.

### SUMMARY

The purpose of the present disclosure is to provide methods and tools for the color mixing of pigments that address the issues of insufficient efficiency and accuracy in existing color mixing technologies.

To solve the above technical problems, the present disclosure provides a method for the color mixing of pigments, which includes: obtaining a first lightness value of the target color; preparing a first formulated pigment based on black and white pigments according to a preset ratio corresponding to the first lightness value, wherein the lightness of the first formulated pigment is equal to the first lightness value; preparing a second formulated pigment based on base hue pigments, wherein the lightness of the second formulated pigment is also the first lightness value, and the hue of the second formulated pigment is the hue of the target color; and mixing the first and the second formulated pigment to obtain a final formulated pigment.

The present disclosure also provides a tool for color mixing of pigments to implement the method above, comprising: a lightness calibration scale with reference holes indicating different lightness values; and a hue calibration scale with reference holes indicating different hues.

In embodiments of the present disclosure, since both the first formulated pigment and the second formulated pigment have the same lightness as that of the target color, the lightness of the final pigment will not change due to changes in the mixing ratio, fundamentally solving the issue of lightness shift caused by subjective mixing in traditional color mixing processes. Furthermore, on the premise that the lightness is ensured, the color mixer can adjust the mix ratio of the two formulated pigments to fine-tune only the coolness/warmth and saturation, making color matching more precise and stable. Additionally, by relying on lightness calibration and preset mixing ratios, the embodiments of the present invention overcome the uncertainty associated with traditional color mixing methods, which depend on an individual's intuitive experience, enabling a higher degree of repeatability and controllability in the mixing process, making it suitable for various practical color mixing scenarios.

### BRIEF DESCRIPTION OF THE DRAWINGS

One or more embodiments of the invention are illustratively described with the drawings corresponding thereto. These illustrative descriptions do not constitute limitations on the embodiments. Elements with the same reference numerals in the drawings represent similar elements. Unless specifically stated otherwise, the drawings are not limiting as to scale.

FIG. 1 is a flowchart of a pigment color mixing method provided by the present invention;

FIG. 2 is a schematic diagram of a lightness calibration ruler in the pigment color mixing method provided by the present invention;

FIG. 3 is an operational schematic of the lightness calibration ruler in the pigment color mixing method provided by the present invention;

FIG. 4 is a schematic of preparing the first formula pigment in the pigment color mixing method provided by the present invention;

FIG. 5 is a schematic diagram of color separation in the pigment color mixing method provided by the present invention;

FIG. 6 is an operational schematic of a color mixing palette in the pigment color mixing method provided by the present invention.

### DETAILED DESCRIPTION OF EMBODIMENTS

In various fields such as painting, design, and industry, professionals regard color mixing as a core skill, with its precision directly impacting visual effects, product quality, and artistic expressiveness. However, conventional methods in existing technologies primarily rely on the individual's intuitive visual perception and long-term experience to manually and gradually mix colors that approximate the target color. Such methods have several notable shortcomings:

1. High Subjectivity and Individual Differences: The paint mixer must undergo extensive training to achieve satisfactory mixing results using intuitive judgment. However, there are significant differences in visual sensitivity and experience accumulation among individuals, leading to varying results when different operators mix the same color. Furthermore, human sensitivity to color is influenced not only by innate factors but also fluctuates due to factors such as fatigue, emotions, or environmental changes, resulting in instability and a lack of repeatability in mixing results.

2. Interference from Environmental Factors: In actual mixing processes, factors such as ambient lighting and background colors can cause visual errors. For example, the simultaneous contrast effect can make the target color appear brighter or darker against different backgrounds, directly affecting the mixer's judgment. Additionally, since the brain's color constancy relies on environmental references, relying solely on intuitive perception makes it challenging to overcome disturbances caused by changes in the external environment, resulting in insufficient precision in color matching during mixing.

3. Lack of Scientific and Systematic Mixing Means: Traditional mixing methods lack quantifiable indicators and standardized tools. The mixing process often involves a trial-and-error approach, lacking scientific control over parameters such as lightness, saturation, and hue, which leads to adjustments that lack clear logic and data support.

4. Low Efficiency and Poor Repeatability: Due to the absence of scientific foundations, paint mixers often need to adjust pigment ratios repeatedly to approximate the target color. This process is not only time-consuming and labor-intensive but also prone to cumulative errors from each operation, which can lead to unstable final mixing results. Moreover, in industrial production or real-time design applications, mixing efficiency directly affects production rhythm and creative processes, making traditional methods inadequate for rapid and precise mixing under high-intensity use.

In summary, existing mixing methods overly rely on an individual's intuitive perception and personal experience, failing to provide a scientific and standardized mixing process. These methods are susceptible to environmental interference, making it challenging to ensure consistency and high precision in color matching. These shortcomings not only limit artistic creativity but also constrain improvements in product quality and production efficiency in fields such as industry and design. Therefore, there is an urgent need to develop a new mixing method based on objective data and systematic processes to achieve precise control over various color parameters (such as lightness, hue, saturation, etc.), thereby significantly improving the efficiency and accuracy of color mixing.

To make the objectives, technical solutions, and advantages of the present invention clearer, the detailed descriptions of various embodiments will be described with the accompanying drawings. Those skilled in the art will understand that many technical details are provided in these embodiments to facilitate understanding of the disclosure. Nevertheless, even without these technical details and various changes and modifications based on the following embodiments, the technical solutions the present disclosure seeks to protect can still be implemented. The division of the embodiments is for convenience of description and should not constitute any limitation on the specific implementation of the invention. The various embodiments can be combined and referenced with each other if they do not contradict one another.

One embodiment of the present disclosure describes a method for mixing pigments, which can be applied by a paint mixer using mixing tools or palettes, or embedded in dedicated color mixing instruments, industrial control systems, or server-side applications, to realize color data acquisition, processing, matching, and output via corresponding software and hardware platforms, thereby meeting the needs of various application scenarios, including artistic creation, industrial production, and real-time mixing. In the embodiment, a first lightness value of a target color is obtained, and a first formulated pigment is prepared based on black and white pigments according to a preset ratio corresponding to the first lightness value, wherein the lightness of the first formulated pigment equals the first lightness value. A second formulated pigment is prepared based on base hue pigments, wherein the lightness of the second formulated pigment is also the same as the first lightness value, and the hue of the second formulated pigment is the hue of the target color. The first formulated pigment and the second formulated pigment is then mixed to obtain the final formulated pigment. Since both the first formulated pigment and the second formulated pigment maintain the same lightness as that of the target color, the lightness of the final pigment will not change due to changes in the mixing ratio, fundamentally solving the issue of lightness shift caused by subjective mixing in traditional processes. Furthermore, with the lightness ensured, the color mixer can adjust the mixing ratio of the two formulated pigments to fine-tune only the hue coolness/warmth and saturation, making color matching more precise and stable. Additionally, by relying on lightness calibration and preset mixing ratios, the embodiment overcomes the uncertainty inherent in traditional mixing methods that depend on the mixer's intuitive experience, and provides a higher degree of repeatability and controllability in the mixing process, making it suitable for various practical mixing scenarios.

Below the implementation details of the method for the color mixing of pigments of the present invention are specifically described. The following is for ease of understanding and is not required for practicing the embodiment.

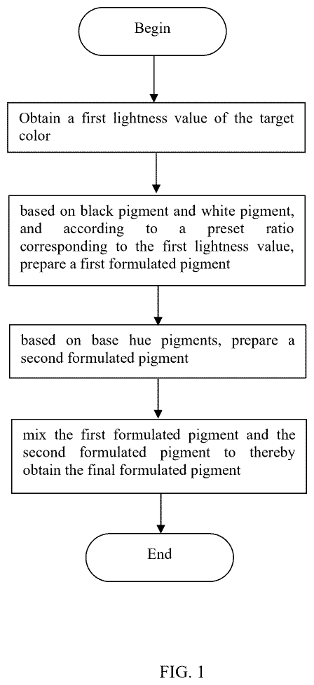

The steps of the method of the invention are shown in FIG. 1, including Steps 101 to 104, specifically as follows:

In Step 101: obtain the first lightness value of the target color. Specifically, in Step 101, a first lightness value (i.e., grayscale value) of the target color is obtained using a lightness calibration scale. This process includes: use color sampling units on the lightness calibration scale to compare with the target color; wherein the lightness calibration scale which provided with at least two color sampling units, each including a color sampling hole and a lightness value scale, with the color sampling hole used to compare the lightness value of the target color; selecting the lightness value scale of the color sampling unit that matches the lightness value of the target color as the first lightness value.

Note that when measuring the lightness value using the lightness calibration scale, the scale is adjusted continuously so that each color sampling hole can be directly compared with the target color. This process continues until a particular color sampling hole is located where the grayscale color matches the lightness of the target color, indicating a successful match. The lightness scale corresponding to the current sampling hole is read as the lightness value of the target color for subsequent pigment mixing.

Optionally, in one embodiment, the lightness calibration scale is arranged with the color sampling units in a progressive order of lightness values, facilitating the determination of the lightness of the target color. For example, the progressive order of lightness values could be 0, 1, 2, 3, 4, 5, 6, 7, 8, 9, 10.

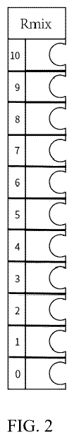

Optionally, as shown in FIG. 2, the lightness calibration scale in the embodiment is designed as a rectangular ruler, with color sampling units arranged along the same direction in progressive order. Each color sampling unit, from left to right, sequentially contains a lightness value scale, a matte-coated paper, and a color sampling hole. The lightness value scale displays standard lightness values (e.g., from 0 to 10). The matte-coated paper has been matte-coated to ensure stable reflection under different lighting conditions; it displays preset grayscale colors, and different sampling units have different displayed lightness. The color sampling hole is used to align with and compare to the target color.

Optionally, the lightness calibration scale may be made of a flexible material for rolling or folding, still allowing a continuous progressive gray scale to be displayed in a strip and suitable for on-site measurement of irregular or large target areas, making it suitable for outdoor or on-site environments.

Optionally, as another alternative, the lightness calibration scale may be designed as a wheel, i.e., multiple sampling units are arranged in sectors to form a ring or semi-ring. Each sector also includes a lightness scale, matte-coated paper, and a sampling aperture. Different sectors represent different lightness values, generally arranged in an ascending order to form a continuous gradient. In use, the user rotates the wheel to position a given sector to the observation position in alignment with the target color. As with the rectangular ruler, when the matte gray of a sector matches the target, its lightness value is read.

Note that the target color includes both a color of a physical object or a color displayed on electronic device screens. That is, the target may be the color of a physical object, such as tables and buildings, as well as the color displayed on screens of electronic devices such as smartphones, computers, televisions, and digital photo albums.

In the above procedure, the lightness calibration scale obtains the corresponding lightness value from the reflectance of the target color, with the specific mapping relationship shown in Table 1.

TABLE 1

| | Lightness value | | | | | | | | | | |
|---|---|---|---|---|---|---|---|---|---|---|---|
| | 0 | 1 | 2 | 3 | 4 | 5 | 6 | 7 | 8 | 9 | 10 |
| LRV | 0 | 5 | 10 | 20 | 30 | 50 | 70 | 80 | 90 | 95 | 100 |
| Reflectance | | | | | | | | | | | |
| (%) | | | | | | | | | | | |

Optionally, in one embodiment, to avoid errors caused by changes in ambient light, the method can include multiple comparisons, followed by taking the average or selecting the most frequently occurring matching value to ensure the stability of the lightness measurement.

In Step 102: Based on black and white pigments, and according to a preset ratio corresponding to the first lightness value (i.e., target gray pigment ratio), prepare a first formula pigment; wherein the lightness of the first formula pigment is the first lightness value.

Optionally, the preparation may include first calculating the required masses of black and white pigments based on the desired mass of the first formulated pigment and the target grayscale pigment ratio. The corresponding masses of black and white pigments are obtained, and then uniformly mixed to obtain the first formulated pigment.

Alternatively, the mixing process may begin with a mass of black pigment designated as “a,” followed by the incremental addition of an equal mass of white pigment until the mixture reaches the target grayscale pigment ratio.

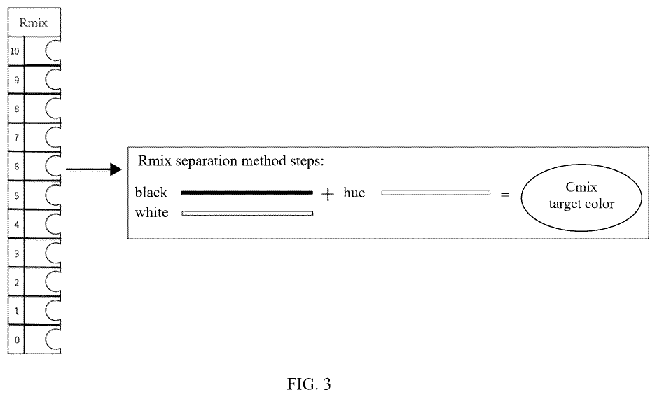

Specifically, in Step 102, the goal is to formulate a pure grayscale pigment (acrhomatic) that matches the first lightness value obtained through the lightness calibration scale in Step 101. To achieve this, a set of mixing ratios for black and white pigments is pre-established to correspond with different values on the lightness scale, thereby facilitating adjustments to reach the target lightness. As shown in FIG. 3, with this preset ratio, once the lightness of the target color is determined (after utilizing the lightness calibration scale), one can directly refer to a corresponding table to obtain the ratio of black and white pigments. Following the “Rmix Separation Method Steps” outlined in FIG. 3, mix the black and white pigments in proportion to obtain the first formulated pigment whose lightness matches the target (i.e., a pure grayscale pigment).

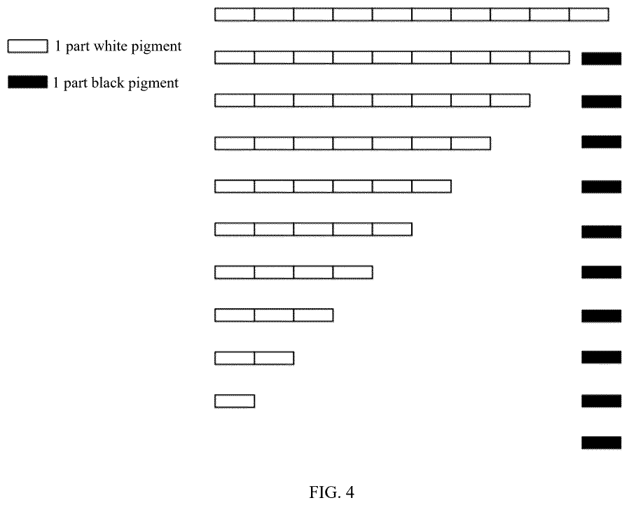

Specifically, as shown in FIG. 4, the ratios of black:white pigments for generating different lightness values are as follows:
when the lightness scale is 0, the preset ratio between the black pigment and white pigment is 1:0; or
when the lightness scale of the sampling unit matching the lightness of the target color is 1, the preset ratio between the black pigment and white pigment is 1:1; or
when the lightness scale of the sampling unit matching the lightness of the target color is 2, the preset ratio between the black pigment and white pigment is 1:2; or
when the lightness scale of the sampling unit matching the lightness of the target color is 3, the preset ratio between the black pigment and white pigment is 1:3; or
when the lightness scale of the sampling unit matching the lightness of the target color is 4, the preset ratio between the black pigment and white pigment is 1:4; or
when the lightness scale of the sampling unit matching the lightness of the target color is 5, the preset ratio between the black pigment and white pigment is 1:5; or
when the lightness scale of the sampling unit matching the lightness of the target color is 6, the preset ratio between the black pigment and white pigment is 1:6; or
when the lightness scale of the sampling unit matching the lightness of the target color is 7, the preset ratio between the black pigment and white pigment is 1:7; or
when the lightness scale of the sampling unit matching the lightness of the target color is 8, the preset ratio between the black pigment and white pigment is 1:8; or
when the lightness scale of the sampling unit matching the lightness of the target color is 9, the preset ratio between the black pigment and white pigment is 1:9; or
when the lightness scale of the sampling unit matching the lightness of the target color is 10, the preset ratio between the black pigment and white pigment is 0:1.

Note that in practical operations, the ratio of black:white pigments according to a preset specific relationship need to be adjusted due to the potential non-linear range and intervals of the lightness calibration scale. For instance, if the changes between the scales exhibit a non-linear pattern (such as logarithmic or power function relationships), one must adjust the ratios according to non-linear mathematical formula, rather than simply applying a ratio of 1 to the scale value.

In Step 102 above, compared to traditional direct mixing methods to achieve the target color, this solution offers advantages by isolating lightness (brightness) for ratio control first, and combining pigments with preset ratios to prepare the grayscale pigment. This method is based on the sensitivity of rod cells in the human retina to light/dark, using a lightness calibration scale to identify the lightness value of the target color. The black and white pigments are then mixed according to preset ratios to ensure that the resulting grayscale pigment matches the lightness of the target color precisely, overcoming errors caused by subjective perceptions in direct mixing processes and greatly improving the scientific rigor and accuracy of the mixing results.

In Step 103: the second formulated pigment is prepared based on the base hue pigments, where the lightness of the second formulated pigment is the first lightness value, and its hue is the hue of the target color.

Specifically, Step 103 includes the following: obtaining the hue of the target color using a hue calibration scale; preparing an intermediate formulated pigment that has the hue of the target color based on the base hue pigments; and adding white and/or black pigment to the intermediate formulated pigment until its lightness value reaches the first lightness value to obtain the second formulated pigment.

In this embodiment, the hue calibration scale comprises multiple hue sampling units, each representing a standard hue, such as red, orange, yellow, green, blue, and purple. The operation of the hue calibration scale is similar to that of the lightness calibration scale, which involves comparing the hue calibration scale to the target color to determine the hue of the matching sampling unit.

Then, based on the target hue, a preliminary intermediate formulated pigment with the desired tone is prepared by selecting or mixing base hue pigments. During this process, different base hue pigments can be mixed according to a preset ratio or mixed based on the paint mixer's experience and visual assessment. At this stage, the primary focus is on hue and saturation, achieving an initial approximation of the target tone, although the lightness may not completely match the target color.

Finally, after obtaining the intermediate formulated pigment with the target color's hue, white pigment or black pigment is gradually added to enhance its lightness (tint) or darkness (shade). White pigment is added incrementally and the lightness is checked after each addition to ensure that the color of the mixture gradually approaches the preset first lightness value while maintaining the target hue. When the added white pigment or black pigment aligns the lightness of the intermediate formulated pigment with the first lightness value, the mixture obtained is the second formulated pigment.

In Step 103, hue and lightness are adjusted separately. First, during the hue phase, an intermediate formulated pigment is prepared based on the sensitivity of cone cells in the human retina to color, using base hue pigments to match the target color. This phase focuses on replicating the hue of the target color without strictly matching the lightness. Next, in the lightness adjustment phase, to address any potential lightness deviations in the preliminary mixture, gradually add white pigment or black pigment to increase the lightness or shade of the mixture, leveraging the sensitivity of rod cells in the human retina to brightness, until it reaches the first lightness value measured using the lightness calibration scale in Step 101. This method allows for precise reproduction of the final color without altering the hue.

In Step 104: the first formulated pigment and the second formulated pigment are mixed to obtain the final formulated pigment.

Specifically, in Step 104, the mixing ratio of the first and second formulated pigments can be continuously adjusted until the saturation of the mixed result matches the saturation of the target color, resulting in the final formulated pigment.

The target color mixing method is based on the Rmix separation method, as shown in FIG. 5, which utilizes the Cmix formula for color mixing. This formula maintains the lightness of the target color R while adjusting the mixing ratios of the grayscale and hue components to achieve a color that perfectly matches the target color. Specifically, the target (i.e., final formulated) color Cmix is defined as:

$$Cmix = R 1 \times P 1 + R 2 \times P 2 , and R 1 = R 2 ;$$

where R1 and R2 represent the lightness values of the components containing only grayscale and only hue, respectively; and P1 and P2 represent the mixing ratios of these two components (satisfying P1+P2=1). Since R1 and R2 are equal, this formula ensures that regardless of how the mixing ratios change, the overall lightness of the final mixed color remains R. Meanwhile, by simply altering the ratios of P1 and P2, the saturation and tone of the color can be adjusted.

In Step 104, the mixer keep adjusting the mixing ratio of the first formulated pigment, which provides the grayscale component, and the second formulated pigment, which provides the target hue, according to the Cmix formula. This process continues until the saturation and tone of the mixed result match entirely the target color. Specifically, when P1 increases, the resulting color tends toward gray; when P2 increases, the resulting color becomes closer to the target hue. This approach ensures constant color lightness while achieving fine control over saturation and tone, thereby establishing a scientific and standardized color mixing scheme.

Note that the target color addressed by the mixing method, from Steps 101 to 104, can be a single color or multiple colors. When there are two or more target colors, a palette can be used to mix multiple colors, which comprises: arranging the first formulated pigment obtained during preparation for each of the at least two target colors along a first direction of the palette, while arranging the second formulated pigments along a second direction that intersects the first.

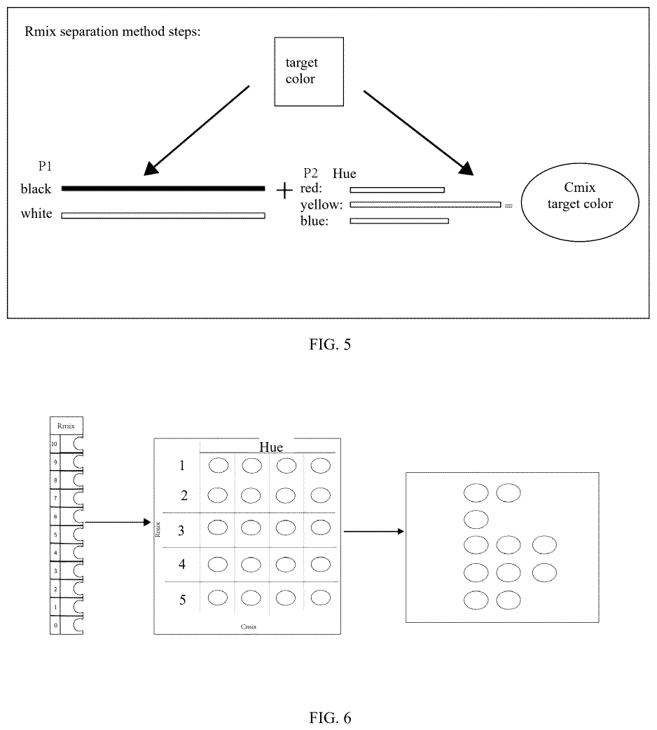

Optionally, when color separation is performed for multiple target colors simultaneously, the steps shown in FIG. 6 can be followed. First, use the lightness calibration scale shown in FIG. 6 to compare different parts (light and dark areas) of each target object, selecting five grayscale ratios (e.g., lightness scales of 1, 2, 4, 7, 9, etc.), and prepare pigments with only lightness based on preset ratios, placing them along a vertical number axis (Y-axis). Then, for each target color, compare with a hue calibration scale or base hue pigments to obtain the corresponding hue information, and each hue pigment is prepared and arranged along the horizontal axis (X-axis). Then, by means of grid intersections (see the palette example in FIG. 6), the corresponding “lightness+hue” combinations at each intersection point can be mixed to obtain multiple final pigments corresponding to the target colors.

In the above embodiment, multiple target colors may be prepared in sequence, that is, after the final formulated pigment for one target color is prepared, the formulated pigments for the next target color can be prepared. Alternatively, the first formulated pigments for all target colors can be prepared first, followed by preparing all second formulated pigments. Finally, each final formulated pigment can be prepared by combining pigments from the first and second formulated pigments to achieve the target colors.

In this embodiment of the disclosure, since both the first and second formulated pigments maintain the same lightness as the target color, the lightness of the final pigment after mixing remains unchanged, regardless of variations in the mixing ratio. This fundamentally resolves the issue of lightness deviation caused by subjective mixing in traditional color mixing processes. Furthermore, with the lightness ensured, the paint mixer can adjust the mixing ratio of the two formulated pigments to fine-tune only the warmth or coolness of the hue and its saturation, making color matching more precise and stable. Additionally, this embodiment relies on lightness calibration and preset mixing ratios to overcome the uncertainty associated with traditional mixing methods, which depend on the mixer's intuitive experience. This results in a mixing process with high repeatability and controllability, making it suitable for various practical color mixing scenarios.

The division of steps above is for clarity; in implementation they may be merged or split, so long as the same logical relationships are included, they fall within the protection scope of the present invention. Insignificant modifications to the algorithm/process or introduction of non-essential designs that do not change the core design are also within the scope of protection of the present invention.

Additionally, the examples mentioned may be freely combined; any combination may be understood as an embodiment. The term “embodiment” or “example” at various places does not necessarily refer to the same embodiment nor exclude others. Those skilled in the art will understand that the embodiments described herein may be combined with other embodiments.

Another embodiment of the present disclosure relates to a set of color mixing tools for pigments designed to implement the pigment mixing method described above. The tools include: a lightness calibration scale with sampling units for indicating different lightness values, and a hue calibration scale with sampling units for indicating different hues.

Optionally, in one embodiment, the tool also includes a palette comprising: a vertical axis formed by color-mixing wells arranged in a first direction, each well for placing a first formulated pigment with the same lightness; a horizontal axis formed by color-mixing wells arranged in a second direction that crosses the first direction, each well for placing a second formulated pigment with the same hue.

Optionally, in one embodiment, the vertical axis is provided with five color-mixing wells along the first direction, while the horizontal axis is provided with four color-mixing wells along the second direction.

In summary, specific embodiments of the subject matter have been described. Other embodiments are within the scope of the appended claims. In some cases, the actions recited in the claims can be performed in a different order and still achieve the desired results. Additionally, the processes depicted in the drawings do not necessarily require the specific order or sequential arrangement shown to achieve the intended outcome.

In the present disclosure, technical terms such as “first,” “second,” and so forth are used solely to distinguish different objects. They should not be interpreted as indicating or implying relative importance or an implicit indication of the quantity, specific order, or primary/secondary relationships of the indicated technical features. In the context of this disclosure, “multiple” means two or more, unless specifically defined otherwise.

In the present disclosure, the term “and/or” merely describes the relationship between associated objects, indicating that three scenarios may exist: A, A and B, or B. Furthermore, the character “/” generally represents an “or” relationship between the associated objects.

In the present disclosure, the term “multiple” refers to two or more (including two). Similarly, “multiple groups” refers to two or more groups (including two), and “multiple pieces” refers to two or more pieces (including two).

In the present disclosure, technical terms such as “center,” “vertical,” “horizontal,” “length,” “width,” “thickness,” “top,” “bottom,” “front,” “back,” “left,” “right,” “vertical,” “horizontal,” “above,” “below,” “clockwise,” “counterclockwise,” “axial,” “radial,” “circumferential,” etc., indicate positional or directional relationships based on the orientations shown in the accompanying figures. These are intended solely for convenience in describing the invention and simplifying explanations, and do not imply that the devices or components must have specific orientations or be constructed or operated in particular ways; thus, they should not be construed as limitations to the invention.

In the present disclosure, unless otherwise expressly provided and limited, technical terms such as “install,” “connect,” “join,” and “fix” should be understood broadly. For example, they can be fixed connections, detachable connections, or integral. They can refer to mechanical or electrical connections and can be directly or indirectly connected through an intermediary. Additionally, they can describe internal communications between two components or interactive relationships between two elements. Those skilled in the art can interpret the specific meanings of these terms in the context of this disclosure based on the circumstances.

The ordinary skilled person in the field will understand that the embodiments are specific implementations of the disclosure, and that various changes can be made in form and detail in practical applications without departing from the spirit and scope of the invention.

What is claimed is:

1. A method for color mixing of pigments, comprising:
obtaining a first lightness value of at least one target color;
based on black pigment and white pigment, and according to a preset ratio corresponding to the first lightness value, preparing the first formulated pigment, wherein the lightness of the first formulated pigment is equal to the first lightness value;
based on base hue pigments, preparing a second formulated pigment, wherein the lightness of the second formulated pigment is equal to the first lightness value, and the hue of the second formulated pigment is the hue of the at least one target color; and
mixing the first and second formulated pigments to obtain the final formulated pigment.

2. The method of claim 1, wherein the at least one target color comprises at least two target colors, the method further comprises:
for each of the at least two target colors, respectively arranging, during preparation, the obtained first formulated pigments along a first direction of a color mixing palette, while arranging the second formulated pigments along a second direction that crosses the first direction.

3. The method of claim 1, wherein mixing the first formulated pigment and the second formulated pigment to obtain the final formulated pigment comprises:
keeping adjusting the mixing ratio of the first and second formulated pigments until the saturation of the mixture matches the saturation of the target color, thereby obtaining the final formulated pigment.

4. The method of claim 1, wherein obtaining the first lightness value of the target color comprises:
using a lightness calibration scale with color sampling units to compare with the target color, wherein the lightness calibration scale includes at least two color sampling units, each containing a color sampling hole and a lightness scale, the color sampling hole is used to compare the lightness of the target color; and
selecting the lightness scale of the color sampling unit that matches the lightness of the target color as the first lightness value.

5. The method of claim 4, wherein the color sampling units are arranged in a progressive order according to their lightness scales.

6. The method of claim 5, wherein the progressive sequence of the lightness scales of the sampling units is 0, 1, 2, 3, 4, 5, 6, 7, 8, 9, 10.

7. The method of claim 6, wherein:
when the lightness scale is 0, the preset ratio between the black pigment and white pigment is 1:0; or
when the lightness scale of the sampling unit matching the lightness of the target color is 1, the preset ratio between the black pigment and white pigment is 1:1; or
when the lightness scale of the sampling unit matching the lightness of the target color is 2, the preset ratio between the black pigment and white pigment is 1:2; or
when the lightness scale of the sampling unit matching the lightness of the target color is 3, the preset ratio between the black pigment and white pigment is 1:3; or
when the lightness scale of the sampling unit matching the lightness of the target color is 4, the preset ratio between the black pigment and white pigment is 1:4; or
when the lightness scale of the sampling unit matching the lightness of the target color is 5, the preset ratio between the black pigment and white pigment is 1:5; or
when the lightness scale of the sampling unit matching the lightness of the target color is 6, the preset ratio between the black pigment and white pigment is 1:6; or
when the lightness scale of the sampling unit matching the lightness of the target color is 7, the preset ratio between the black pigment and white pigment is 1:7; or
when the lightness scale of the sampling unit matching the lightness of the target color is 8, the preset ratio between the black pigment and white pigment is 1:8; or
when the lightness scale of the sampling unit matching the lightness of the target color is 9, the preset ratio between the black pigment and white pigment is 1:9; or
when the lightness scale of the sampling unit matching the lightness of the target color is 10, the preset ratio between the black pigment and white pigment is 0:1.

8. The method of claim 1, wherein preparing the second formulated comprises:
obtaining the hue of the target color through a hue calibration scale;
based on base hue pigments, preparing an intermediate formulated pigment having the hue of the target color; and
add white pigment or black pigment to the intermediate formulated pigment until its lightness reaches the first lightness value, thus obtaining the second formulated pigment.

9. The method of claim 1, wherein the target color is a color of a physical object or a color displayed on an electronic device screen.

10. A set of tools for color mixing for implementing the pigment mixing method according to claim 1, including:
a lightness calibration scale, which has color sampling units for indicating different lightness values; and
a hue calibration scale, which has color sampling units for indicating different hues.
